(19) United States
(12) Patent Application Publication
(10) Pub. No.: US 2007/0273461 A1
(43) Pub. Date: Nov. 29, 2007

(54) Electro-Magnetic Force Driving Actuator and Circuit Breaker Using the Same

(76) Inventors: Jong-Ho Kang, Seoul (KR); Hyun-Kyo Jeong, Seoul (KR)

Correspondence Address: DICKSTEIN SHAPIRO LLP, 1825 EYE STREET NW, Washington, DC, 20006-5403, US

(21) Appl. No.: 10/587,572

(22) PCT Filed: Feb. 11, 2005
(86) PCT No.: PCT/KR05/00388

§ 371 Date: Jul. 17, 2007

(30) Foreign Application Priority Data
Feb. 11, 2004 (KR) 10-2004-0008966
Feb. 7, 2005 (KR) 10-2005-0011263

(51) Int. Cl. H01H 83/00; H01F 6/00

(52) U.S. Cl. 335/6; 335/216

(57) ABSTRACT

Disclosed are an electro-magnetic force driving actuator and a circuit breaker comprising the actuator. The actuator comprises a hollow inner case made of magnetic material; an outer case made of magnetic material and being concentric with the inner case and radially mounted at an interval outwardly from the inner case; inner and outer permanent magnets abutting on an outer surface of the inner case and an inner surface of the outer case, respectively and positioned to maintain a predetermined gap between the magnets; a coil mounted to be linearly movable in an axial direction between the inner and outer permanent magnets; and a non-magnetic movable member having an end to which the coil is provided and linearly moving in the axial direction between the inner and outer permanent magnets with electromagnetic repulsive forces occurring due to magnetic fields by the inner and outer permanent magnets and a current density of the coil when current is supplied to the coil. The circuit breaker comprises the actuator and an insulation-actuating rod connected to another end of the movable member and linearly moving by the movable member to perform closing and opening operations.

### TECHNICAL FIELD

The present invention relates to an actuator and a circuit breaker used to an electric power system, and more particularly to an actuator using an electromagnetic repulsive force capable of maximizing actuating speed and force while having small size and weight and a circuit breaker usefully applied for high pressure and super-high pressure circuit breakers by exhibiting an excellent circuit-breaking performance using the actuator and also easily applied for a low pressure circuit breaker.

### BACKGROUND ART

A circuit breaker is mainly mounted to a power transmission end and a power receiving end of a power transmission line. The breaker opens and closes a normal current when there is no failure in an electric power system and also breaks a fault current when there occurs a failure such as a circuit short, thereby protecting the system and various power devices (load).

The circuit breaker is classified into a vacuum circuit breaker (VCB), an oil circuit breaker (OCB) and a gas circuit breaker (GCB), etc. according to arc extinguishing/insulating media.

When the circuit breaker breaks the fault current, an arc occurring between two contacting points should be extinguished. The gas circuit breaker is also classified into a puffer arc-extinguishing type, a rotating arc-extinguishing type, a thermal expansion arc-extinguishing type and a hybrid arc-extinguishing type, etc. according to arc-extinguishing types.

FIGS. 1 and 2 show an example of the puffer arc-extinguishing type of the gas circuit breaker.

The puffer arc-extinguishing type of the gas circuit breaker uses SF6 gas (sulfur hexafluoride, which is hereinafter referred to as an arc-extinguishing gas) as the arc-extinguishing/insulating gas and is mainly used for a super-high pressure (typically, 72.5 kV or more) circuit breaker.

As shown in FIGS. 1 and 2, the puffer arc-extinguishing type of the gas circuit breaker comprises a breaking section 10 for breaking a fault current and an actuator 50 for actuating the breaking part 10.

The breaking section 10 consists of a stationary member and a movable member and is mounted to a vessel filled with the SF6 gas.

The stationary member of the breaking part 10 includes a static arc contact 11, a static main contact 12, an insulation case 13, a fixed piston 14, a supporting member 15 and a supporting insulator 16.

The movable member of the breaking part 10 comprises a movable arc contact 21, a movable main contact 22, an insulation nozzle 23, a puffer cylinder 24 and an insulation-actuating rod 25.

An actuating rod 51 of the actuator 50 is connected to the insulation-actuating rod 25. In addition, the movable arc contact 21, the movable main contact 22, the insulation nozzle 23 and the puffer cylinder 24 are also integrally connected to the insulation-actuating rod 25.

Accordingly, when the actuator 50 is driven, the insulation-actuating rod 25 is moved by the actuating rod 51. Then, as the insulation-actuating rod 25 is moved, the movable arc contact 21, the movable main contact 22, the insulation nozzle 23 and the puffer cylinder 24 are integrally moved to perform a closing operation (conducting the current) and an opening operation (interrupting the current).

More specifically, under normal state, the closed state is maintained and a normal current flows as shown in FIG. 1.

However, when there occurs an abnormality in the electric power system and thus a fault current several times higher than the normal current (for example, about 10 times) flows, the actuator 50 is actuated by the fault current. Then, as shown in FIG. 2, the actuator 50 draws the actuating rod 51 which in turn draws the insulation-actuating rod 25. Accordingly, the movable arc contact 21 is separated from the static arc contact 11 and the movable main contact 22 is separated from the static main contact 12.

At the same time, the puffer cylinder 24 is drawn in a direction opposing to the fixed piston 14, so that the arc-extinguishing gas in the puffer cylinder 24 is compressed. The compressed arc-extinguishing gas passes through an air supply aperture 17 and a flow path and is ejected in an arrow direction of FIG. 2, so that it rapidly extinguishes an arc plasma occurring between the static arc contact 11 and the movable arc contact 21 to interrupt the current (opened state).

With the above circuit breaker, the opening operation should be performed at high speed in order to interrupt the fault current and to quickly recover the insulation between electrodes. However, since the arc is not completely extinguished just by increasing a stroke length (SL) due to the arc plasma, the arc-extinguishing gas should be ejected as described above. Accordingly, the actuator 50 should bear even a force for compressing the arc-extinguishing gas, i.e., a force for driving the puffer cylinder 24 against the fixed piston 14. In other words, since the actuating force should be highly increased to increase the opening speed, it is required the higher force and speed for the actuator 50.

For example, the circuit breaker for high/super-high pressures (typically, 365 kV or more) for the power transmission has about 250 mm of stroke length (SL) and requires force and speed high enough to complete the operations within an extremely instantaneous time, such as 35 ms.

The current circuit breaker for high/super-high pressures is mainly provided with a hydraulic or pneumatic actuator. However, such actuators make up about ⅓ of the total cost of the circuit breaker and Korea industries mostly depends on the imports thereof. In addition, the hydraulic or pneumatic actuator has a disadvantage of a leakage of an operating fluid according to a change of surrounding temperature. Further, since the actuator consists of many parts, it may not operate even when only one part is out of order.

Accordingly, researches for developing an actuator capable of replacing the hydraulic or pneumatic actuator has been world-widely conducted. As the research results, a spring (spiral spring) actuator, a motor drive (which is a system of converting a rotational movement into a linear movement using a motor) and a permanent magnetic actuator (PMA) are representatively used.

Since the spring actuator is a system obtaining a power by releasing a compressed force as necessary under compressed state of the spring, a manufacturing cost is inexpensive. However, since an elastic force of the spring is not constant, a reliability of the operation is low. Accordingly, it is difficult to apply the spring actuator for the high or super-high pressure circuit breaker which should eject the arc-extinguishing gas, and a possibility of the breaking failure is very high even though it is applied.

The motor drive is inexpensive compared to the pneumatic or hydraulic actuator. However, it is still expensive and difficult to exert a high force. Accordingly, although the motor drive may be used for the low pressure, it cannot exhibit an enough performance in the high or super-high pressure.

The PMA actuator drives a movable member using a force of a magnetic field occurring in the permanent magnet and an electromagnetic force due to a magnetic field occurred by flowing a current in a coil. Accordingly, it has a very simple structure and a good operating efficiency and is expected to operate constantly and uniformly, so that it is recently much used as an actuator for a low pressure circuit breaker.

However, since the PMA actuator is a system which should be driven by the force of the magnetic field occurring in the permanent magnet and the force of the magnetic field occurred by flowing the current in the coil, a path in which the magnetic field flows should be made of magnetic material (iron core) and the movable member to be driven should be also made of magnetic material. Accordingly, when it is required a higher force for the actuator due to an increased breaking capacity, many magnetic fields should be generated and the magnetic material should be also larger as much as so that the magnetic fields can flow without being saturated (magnetic saturation state: when the magnetic material is magnetized to what extent, it reaches ‘a magnetic saturation state’ in which the magnetic material is not magnetized even though the higher current is applied and a force having a certain limit or more cannot be obtained even though continuously increasing the current). Therefore, there increase a burden of a size of the actuator. Further, since a magnetic flux density excited in the permanent magnet and the coil is in inverse proportion to a square of a void length, there is a limitation of applying the PMA actuator to the high or super-high pressure circuit breaker in which the gap between the contacting points of the breaking section is high. For example, when the PMA actuator is applied to a low pressure circuit breaker having about 20 mm of stroke length, a size of an optimized model is 200×250×100 mm (width×length×thickness), so that a weight thereof is 10 kg or more. Accordingly, when the PMA actuator is used for the high-pressure, the size thereof should be enlarged, the weight is also much heavier compared to the hydraulic or pneumatic actuator and the manufacturing cost is thus increased. Therefore, the PMA actuator has not been used for the high or super-high pressure.

### DISCLOSURE OF INVENTION

### Technical Problem

Accordingly, the present invention has been made to solve the above-mentioned problems occurring in the prior art. The object of the present invention is to provide an actuator using an electromagnetic force capable of maximizing actuating speed and force while having small size and weight and a circuit breaker usefully applied for high pressure and super-high pressure circuit breakers by exhibiting an excellent breaking performance using the actuator and also easily applied for a low pressure circuit breaker.

### Technical Solution

In order to accomplish the object, according to a first embodiment of the invention, there is provided an actuator comprising a hollow inner case made of magnetic material; an outer case made of magnetic material and being concentric with the inner case and radially mounted at an interval outwardly from the inner case; inner and outer permanent magnets abutting on an outer surface of the inner case and an inner surface of the outer case, respectively and positioned to maintain a predetermined gap between the magnets; a coil mounted to be linearly movable in an axial direction between the inner and outer permanent magnets; and a non-magnetic movable member having an end to which the coil is provided and linearly moving in the axial direction between the inner and outer permanent magnets with electromagnetic repulsive forces occurring due to magnetic fields by the inner and outer permanent magnets and a current density of the coil when current is supplied to the coil.

According to the first embodiment of the invention, since the actuator has such structure that the movable member is operated with the forces occurring due to the magnetic fields by the permanent magnets and an electric field by the coil current, it exerts high actuating force and speed even with small size and weight.

According to the first embodiment of the invention, the non-magnetic movable member may comprise a movable ring having an end to which the coil is provided and being mounted to be linearly movable in the axial direction between the inner and outer permanent magnets; and a movable shaft mounted to be linearly movable in the inner case and linearly moving in the axial direction by the movable ring due to an end thereof connected to the movable ring.

According to the first embodiment of the invention, the inner and outer permanent magnets may consist of a superconducting magnet.

According to the first embodiment of the invention, the actuator may preferably further comprise first and second end plates made of magnetic material and blocking both ends of the inner and outer cases to induce a smooth flow of the magnetic fields.

According to the invention, there is provided a circuit breaker comprising a hollow inner case made of magnetic material; an outer case made of magnetic material and being concentric with the inner case and radially mounted at an interval outwardly from the inner case; inner and outer permanent magnets abutting on an outer surface of the inner case and an inner surface of the outer case, respectively and positioned to maintain a predetermined gap between the magnets; a coil mounted to be linearly movable in an axial direction between the inner and outer permanent magnets; a non-magnetic movable member having an end to which the coil is provided and linearly moving in the axial direction between the inner and outer permanent magnets with electromagnetic repulsive forces occurring due to magnetic fields by the inner and outer permanent magnets and a current density of the coil when current is supplied to the coil; and an insulation-actuating rod connected to another end of the movable member and linearly moving by the movable member to perform closing and opening operations.

According to the circuit breaker of the invention, the inner and outer permanent magnets may consist of a superconducting magnet.

According to the circuit breaker of the invention, the non-magnetic movable member may comprise a movable ring having an end to which the coil is provided and being mounted to be linearly movable in the axial direction between the inner and outer permanent magnets; and a movable shaft mounted to be linearly movable in the inner case, having an end connected to the movable ring and another end connected to the insulation-actuating rod and linearly moving in the axial direction by the movable ring to move the insulation-actuating rod.

According to an embodiment of the invention, the circuit breaker may further comprise first and second end plates made of magnetic material and blocking both ends of the inner and outer cases to induce a smooth flow of the magnetic fields.

According to an embodiment of the invention, the circuit breaker may further comprise a buffering means mounted adjacent to a region that is at an end of the opening movement of the movable member and absorbing a shock force.

According to a preferred embodiment of the invention, the buffering means may consist of a compressible coil spring.

According to a second embodiment of the invention, there is provided an actuator comprising a body made of magnetic material and having a circular chamber formed therein; circular inner and outer permanent magnets concentrically mounted at a radial interval in the chamber of the body; and a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil.

According to the second embodiment of the invention, both ends of the inner and outer permanent magnets may be provided with first circular inner and outer supplementary permanent magnets and second circular inner and outer supplementary permanent magnets, respectively, and the movable member may be integrated with the coil by positioning first and second circular magnetic rings to both ends of the coil, respectively.

According to an embodiment of the invention, polarities of the first inner and outer supplementary permanent magnets and the second inner and outer supplementary permanent magnets are preferably positioned in an opposite direction to those of the inner and outer permanent magnets.

According to an embodiment of the invention, the inner and outer permanent magnets may consist of a superconducting magnet.

According to the second embodiment of the invention, it is preferred that the coil and the first and second magnetic rings are embedded in an insulating housing to be integrated with it.

According to an embodiment of the invention, the insulating housing is preferably made of plastic material.

According to the second embodiment of the invention, both ends of the movable member may be provided with first and second buffering means in order to prevent the ends of the movable member from colliding with the body at the end of the axial movement of the movable member.

According to an embodiment of the invention, the first and second buffering means may consist of a compressible coil spring.

Alternatively, the first and second buffering means may consist of a compressible coil spring and be positioned between the inner and outer permanent magnets.

According to the second embodiment of the invention, a plurality of non-magnetic rods may be connected to an end of the movable member and a supporting member may be mounted to ends of the non-magnetic rods for connecting to a driven part.

According to another embodiment of the invention, there is provided a circuit breaker comprising the actuator according to the second embodiment and an insulation-actuating rod connected to the movable member in order to linearly move by the movable member of the actuator and thus to perform opening and closing operations.

According to a third embodiment of the invention, there is provided an actuator comprising a plurality of electromagnetic force driving actuating parts mounted in a body made of magnetic material, each of the actuating parts including circular inner and outer permanent magnets concentrically mounted to maintain a radial interval between the magnets; a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil; a plurality of rods connected to the movable members; and a supporting member connecting ends of the rods.

According to the third embodiment of the invention, both ends of the inner and outer permanent magnets may be provided with first circular inner and outer supplementary permanent magnets and second circular inner and outer supplementary permanent magnets, respectively, and the movable member may be integrated with the coil by providing first and second circular magnetic rings to both ends of the coil, respectively.

According to an embodiment of the invention, the inner and outer permanent magnets may consist of a superconducting magnet.

According to still other embodiment of the invention, there is provided a circuit breaker comprising the actuator according to the third embodiment of the invention and an insulation-actuating rod connected to the supporting member in order to linearly move by the movable members and thus to perform closing and opening operations.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view of a puffer arc-extinguishing type of a circuit breaker according to the prior art under closed state;

FIG. 2 is an enlarged view showing a breaking section shown in FIG. 1 under arc-extinguishing state;

FIG. 3 is a sectional view of an actuator according to a preferred first embodiment of the invention;

FIG. 4 is a sectional view taken along a line A-A in FIG. 3;

FIGS. 5 to 7 show a structure of a circuit breaker provided with the actuator according to the first embodiment of the invention and sequentially illustrate that the circuit breaker is changed from a closed state to an opened state via an arc-extinguishing state;

FIG. 8 is a three dimensional sectional view showing a structure of an actuator according to a preferred second embodiment of the invention;

FIGS. 9 and 10 are detailed views showing constituting elements of the actuator according to the second embodiment of the invention;

FIG. 11 is a sectional view of a circuit breaker provided with the actuator according to the second embodiment of the invention;

FIGS. 12 to 15 are sectional view of sequentially showing operating stages of the actuator according to the second embodiment of the invention;

FIGS. 16 and 17 are graphs showing characteristics of a force moving a movable member and a current when the actuator according to the second embodiment of the invention is provided with inner and outer permanent magnets only, without first and second magnetic rings and supplementary permanent magnets;

FIGS. 18 and 19 are graphs showing characteristics of a force and a current when the actuator according to the second embodiment of the invention is further provided with first and second magnetic rings and supplementary permanent magnets; and

FIGS. 20 and 21 are a plan view and a three dimensional sectional view showing a structure of an electromagnetic force driving actuator according to a third embodiment of the invention, respectively.

### BEST MODE FOR CARRYING OUT THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

### Example 1

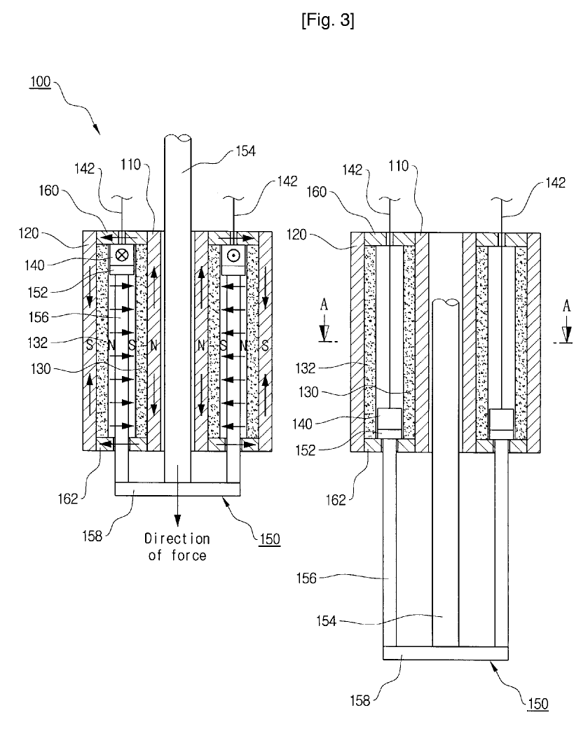

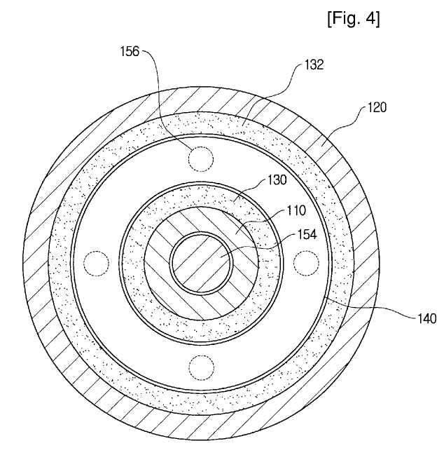

FIGS. 3 and 4 show an actuator according to a first preferred embodiment of the invention. FIG. 3 is a sectional view showing a structure of the actuator and FIG. 4 is a sectional view taken along a line A-A in FIG. 3.

In FIG. 3, a right view shows a state before the actuator is operated (i.e., closed state) and a left view shows a state after the actuator is operated (i.e., opened state).

As shown in FIGS. 3 and 4, the actuator 100 according to the invention is an electro-magnetic force driving actuator (EMFA) and comprises an inner case 110, an outer case 120, inner and outer permanent magnets 130, 132, a coil 140 and a movable member 150.

The inner and outer cases 110, 120 are made of magnetic material and concentrically positioned to maintain a predetermined radial interval between them.

The inner permanent magnet 130 is mounted to abut on an outer surface of the inner case 110 and the outer permanent magnet 132 is mounted to abut on an inner surface of the outer case 120. Accordingly, the inner and outer permanent magnets 130, 132 maintain a predetermined radial interval between them.

The coil 140 is mounted to be linearly movable in an axial direction between the inner and outer permanent magnets 130, 132. The coil 140 is supplied with current by a power supply line 142.

The movable member 150 is made of non-magnetic material and the coil 140 is provided to an end thereof. Therefore, the movable member 150 linearly moves in the axial direction between the inner and outer permanent magnets 130, 132 with forces occurring due to ‘magnetic fields’ by the inner and outer permanent magnets 130, 132 and an ‘electric field’ by the current of the coil 140 when the current is supplied to the coil 140.

In the embodiment shown in FIGS. 3 and 4, the movable member 150 comprises a movable ring 152 and a movable shaft 154.

More specifically, the movable ring 152 is mounted to be linearly movable in the axial direction between the inner and outer permanent magnets 130, 132. The coil 140 is mounted to an end of the movable ring 152. Accordingly, when the current is supplied to the coil 140, the movable ring 152 linearly moves in the axial direction together with the coil 140.

The movable shaft 154 is mounted to be linearly movable in a center of the inner case 110. At the same time, an end of the movable shaft 154 is connected to the movable ring 152. Therefore, the movable shaft 154 linearly moves in the axial direction together with the movable shaft 152.

In the embodiment of the invention shown in FIG. 3, the movable ring 152 and the movable shaft 154 are integrated by connecting shafts 156 and a connecting plate 158.

The plurality of connecting shafts 156 are extended from the movable ring 152 and the connecting plate 158 is connected to ends of the connecting shafts 156.

The movable shaft 154 is extended from a center of the connecting plate 158 and inserted into the inner case 110 to be linearly movable.

In the mean time, both ends of the inner and outer cases 110, 120 are provided with first and second end plates 160, 162. The end plates 160, 162 are made of magnetic material and serves to block both ends of the inner and outer cases 110, 120 and thus to induce a smooth flow of the magnetic fields between the inner and outer cases 110, 120. In this case, the connecting shaft 156 passes through the second end plate 162 and is connected to the connecting plate 158.

The actuator structured as described above is an electromagnetic force driving actuator (EMFA) which linearly moves the movable member 150 using forces occurring due to the magnetic fields by the permanent magnets 130, 132 and the electric field by the current of the coil 140 by applying a Fleming's left-hand law.

As shown in left of FIG. 3, when the current is applied to the coil 140 of the actuator 100, forces act which move the coil 140 in the axial direction by the magnetic fields of the permanent magnets 130, 132 and the electric field of the coil 140. Thereby, the coil 140 is moved in the axial direction together with the movable member 150.

More specifically, when the current flows to the coil 140 in a direction as shown in left of FIG. 3, the coil 140 is applied with a force moving it downwardly, so that the coil 140 and the movable ring 152 are moved downwardly.

When the movable ring 152 is downwardly moved and the connecting shaft 152 connected to the movable ring 154 is thus downwardly moved, it is maintained a state as shown in the right of FIG. 3.

The actuator 100 structured as described above has a principle of obtaining force moving in the axial direction by flowing the current to the coil 140, which is in the space formed with the magnetic fields by the permanent magnets 130, 132, in a direction perpendicular to the magnetic fields.

As described above, since the general PMA actuator according to the prior art is a system of moving the movable member with the force of the magnetic field occurring from the permanent magnet and the force of the magnetic field occurring from the current flowing in the coil, a path in which the magnetic fields flow should be made of magnetic material and the movable member should be also made of magnetic material.

Accordingly, much current should be applied to the coil in order to obtain higher actuating force. However, since the magnetic material is saturated, it is impossible to a predetermined limit or more of the actuating force even though the current is continuously increased. In addition, since the size of the magnetic material should be increased to solve the problems, the actuator becomes too larger. Further, since a magnetic flux density excited by the permanent magnet and the coil current is in inverse proportion to a square of a void length, there is a limitation of applying the PMA actuator to the high or super-high pressure circuit breaker in which the gap between the contacting points of the breaking section is high.

However, in the actuator according to the invention, the current is made to flow in a direction perpendicular to a space formed with the magnetic fields using a Fleming's left-hand law, thereby providing a force, i.e., F=∫(J X B)du (J: current density, B: magnetic flux density) for the movable member.

The magnetic field by the prior permanent magnet has a problem of saturation of the magnetic material as described above and the magnetic flux density is highly affected by the void length. However, according to the actuator 100 of the invention, under state that the magnetic field is formed in a region adjacent to the coil 140 by the permanent magnet, since the current density by the current of the coil 140 is formed in a direction perpendicular to the magnetic field and an electromagnetic repulsive force according to the Fleming's left hand law is used, the current applied to the coil 140 is immediately converted into a force. Accordingly, when much current is applied to the coil 140, it is possible to obtain a higher force as much as that.

Accordingly, since the actuator 100 of the invention is operated by the electro-magnetic repulsive force due to an external magnetic flux density and the current density in the area of the coil 140, rather than using the force which the electro-magnetic force occurring from the magnetic field excited by the current of the coil 140 exerts on the void, it is possible to obtain the higher actuating force just by winding more coils 140 and increasing the intensity of the current without considering the saturation of the magnetic material influenced by the electromagnetic force, so that the size and weight of the actuator can be drastically reduced. In other words, it is possible to obtain a very higher actuating force compared to the size and weight.

In the mean time, a sufficient magnetic flux density should be formed in the void between the movable member and the iron core (stator) in the PMA actuator according to the prior art. Since the magnetic flux density is in inverse proportion to a square of a void length, much current should be applied to the coil so as to form the sufficient magnetic flux density. Accordingly, a reactivity, i.e., an initial operating speed is inevitably slow. However, according to the actuator 100 of the invention, since the electromagnetic repulsive force repulsing with the external magnetic field occurs at the same time that the current is supplied to the coil 140, the initial operating speed is very fast and strong.

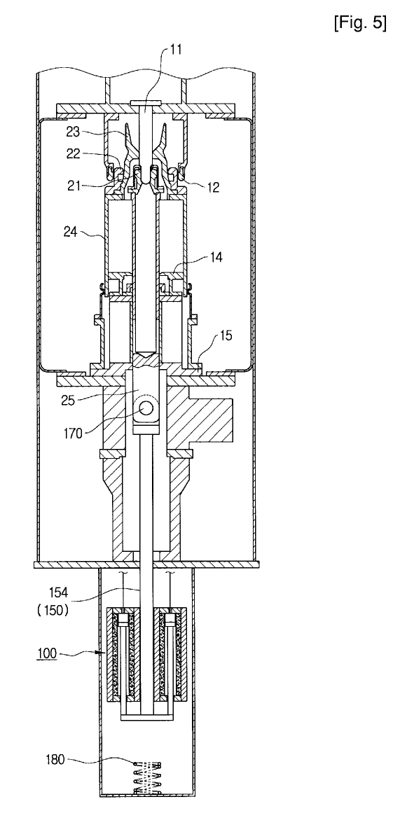

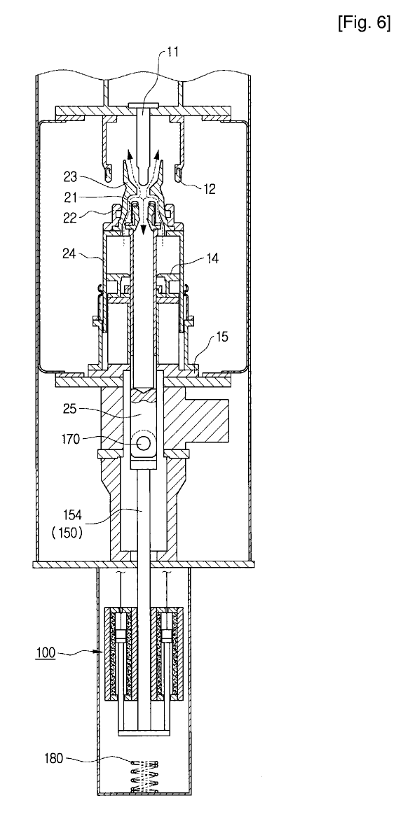

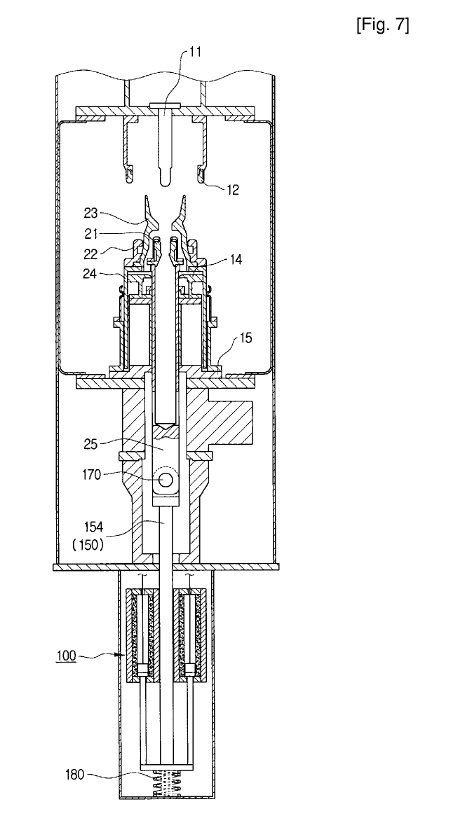

FIGS. 5 to 7 show a structure of a circuit breaker according to a preferred embodiment of the invention using the above actuator, wherein FIG. 5 shows a closed state of the circuit breaker, FIG. 6 shows an arc-extinguishing state of the circuit breaker and FIG. 7 shows an opening completion state of the circuit breaker.

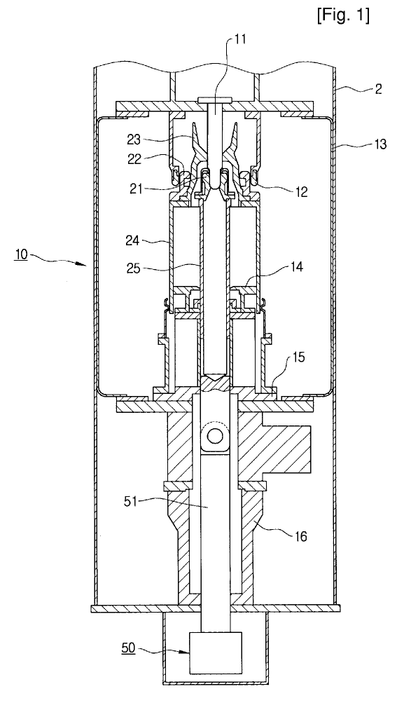

In Figs., same reference numerals are used for the same constituting elements as shown in FIGS. 1 to 4 and overlapped explanations will be omitted.

As shown in FIGS. 5 to 7, according to the circuit breaker of the invention, the insulation-actuating rod 25 is connected to the end of the movable member 150 of the actuator 100. Therefore, the insulation-actuating rod 25 is moved in the axial direction by the movement of the movable member 150, thereby performing the closing and opening operations.

Specifically, an end of the insulation-actuating rod 25 is connected to an end of the movable shaft 155 of the movable member 150 through a pin 170.

With the circuit breaker according to this embodiment, the ends of the insulation-actuating rod 25 and the movable shaft 154 of the movable member 150 may be directly connected to each other as shown in FIGS. 5 to 7 or may be connected to each other via a linking mechanism, etc.

With the circuit breaker according to this embodiment, it is preferred that a buffering means 180 is provided adjacently to a region that is at an end of the opening movement of the movable member 150. The buffering means 180 serves to absorb or attenuate a shock resulting from that the movable ring 152 of the movable member 150 collides with the second end plate 162 when the movable member 150 moves in the opening direction. As shown in Figs., the buffering means 180 may consist of a compressible coil spring.

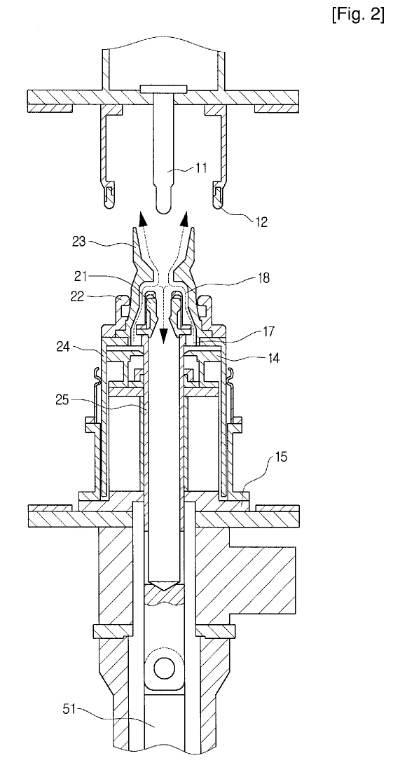

The circuit breaker structured as described above comprises the actuator 100 according to the first embodiment of the invention. Since the detailed breaking operations of the circuit breaker were already explained with reference to FIGS. 1 and 2 and the operations of the actuator 100 were described with reference to FIGS. 3 and 4, overlapped explanations will be avoided.

Firstly, when there occurs an abnormality in the electric power system and thus a fault current several times higher than the normal current flows under the closed state as shown in FIG. 5, the coil 140 of the actuator 100 is supplied with the current. Then, as shown in FIG. 6, as the coil 140 and the movable member 150 move, they draw the insulation-actuating rod 25. Accordingly, the movable arc contact 21 is separated from the static arc contact 11 and the movable main contact 22 is separated from the static main contact 12. Thereby, the puffer cylinder 24 is drawn in a direction opposing to the fixed piston 14, so that the arc-extinguishing gas in the puffer cylinder 24 is compressed. The compressed arc-extinguishing gas is ejected through the air supply aperture 17 and the flow path 18, thereby extinguishing the arc plasma occurring between the static arc contact 11 and the movable arc contact 21.

After that, when the movable member 150 is further retreated to further draw the insulation-actuating rod 25, a completely opened state is achieved as shown in FIG. 7.

At this time, at the end of the movement of the movable member 150, the end of the movable member 150 collides with the buffering means 180, so that the shock force is absorbed. Accordingly, since the moving speed of the movable member 150 is reduced at the last stage of the opening operation, the movable ring 152 of the movable member 150 does not collide with the second end plate 162.

As described above, it is required force and speed high enough to complete the operations within the instantaneous period so that the circuit breaker interrupts the fault current and the insulation between the electrodes is rapidly recovered. In particular, an actuator having a very high actuating force is required in a high/super-high pressure circuit breaker having a high breaking capacity.

With the circuit breaker according to the invention, since there is provided the actuator 100 operating with the electromagnetic repulsive force, it is not necessary to consider the saturation of the magnetic material. Accordingly, since it is possible to obtain higher actuating force just by winding more coils 140 and increasing the intensity of the current, a very higher actuating force can be obtained compared to the size and weight of the actuator. Therefore, the actuator of the invention has a very fast initial speed.

Thus, the circuit breaker using the actuator 100 according to the invention can exhibit a very excellent performance in the 365 kV or more of high/super-high pressure circuit breaker to which it was difficult to apply the actuator of the prior art.

In particular, the circuit breaker according to the invention can also exhibit a very excellent performance in the gas arc-extinguishing circuit breaker which should bear even a force for compressing the arc-extinguishing gas and the puffer arc-extinguishing type of gas arc-extinguishing circuit breaker.

Further, since the circuit breaker of the invention can increase or decrease the size and actuating force thereof by adjusting the winds of the coil, etc., it can be applied for the low pressure with a small size and weight as well as for the high/super-high pressure circuit breaker.

In the above explanations, although the puffer arc-extinguishing type of circuit breaker shown in Figs. is described as an example, the actuator of the invention can be applied to most of the circuit breakers requiring high force and speed, such as a vacuum circuit breaker, an oil circuit breaker, a rotating arc-extinguishing type of circuit breaker, a thermal expansion arc-extinguishing type of circuit breaker and a hybrid arc-extinguishing type of circuit breaker, etc. and has a very high efficiency.

### Example 2

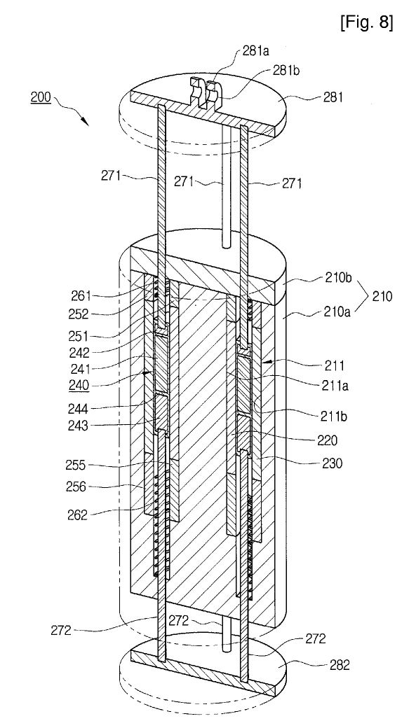

FIGS. 8 to 10 show an actuator according to a second embodiment of the invention. The actuator according to the second embodiment is a modified form of the electro-magnetic force driving actuator (EMFA) according to the first embodiment of the invention.

As shown in FIG. 8, the actuator 200 according to the second embodiment comprises a magnetic body 210 having a circular chamber 211 formed therein, a circular inner permanent magnet 220 and a circular outer permanent magnet 230 concentrically mounted to maintain a predetermined radial interval between them in the chamber 211 of the body 210, and a circular movable member 240 having a circular coil 241 and mounted to be linearly movable in an axial direction between the inner and outer permanent magnets 220, 230.

The movable member 240 having the coil 241 is linearly moved in the axial direction between the inner and outer permanent magnets 220, 230 with forces occurring due to magnetic fields by the inner and outer permanent magnets 220, 230 and an electric field by the current of the coil 241 when current is supplied to the coil 241.

It is preferred that the body 210 is divided into a first body 210a and a second body 210b connected to each other, in order to mount the inner and outer permanent magnets 220, 230 and the movable member 240.

In this embodiment, both ends of the coil 241 of the movable member 240 may be provided with a first circular magnetic ring 242 and a second circular magnetic ring 243 to be integrated with the coil 241. The integration of the coil 241 and the first and second magnetic rings 242, 243 may be achieved by embedding the coil 241 and the first and second magnetic fields 242, 243 in an insulating housing 244. Magnitudes (lengths) of the first and second magnetic rings 242, 243 may be different from each other according to a holding force of a driven body. For example, the lengths may be different according to a difference between a holding force required to continuously maintain a closed state of the circuit breaker and a holding force required to continuously maintain an opened state of the circuit breaker.

First circular inner and outer supplementary permanent magnets 251, 252 and second circular inner and outer supplementary permanent magnets 255, 256 may be respectively provided to both ends of the inner and outer permanent magnets 220, 230, correspondingly to the first and second magnetic rings 242, 243.

Polarities of the first inner and outer supplementary permanent magnets 251, 252 and second inner and outer supplementary permanent magnets 255, 256 are made to be opposite to those of the inner permanent magnet 220 and the outer permanent magnet 230. Thus, directions of lines of magnetic force occurring between the first inner and outer supplementary permanent magnets 251, 252 and lines of magnetic force occurring between the second inner and outer supplementary permanent magnets 255, 256 become opposite to those of lines of magnetic force occurring between the inner permanent magnet 220 and the outer permanent magnet 230. By doing so, when the movable member 240 moves upwardly in FIG. 8, the first magnetic ring 242 is held with the magnetic forces by the first inner and outer supplementary permanent magnets 251, 252, so that the upwardly moved state of the movable member 240 can be continuously maintained even though the current supply to the coil 241 is interrupted. Likewise, when the movable member 240 moves downwardly in FIG. 8, the second magnetic ring 243 is held with the magnetic forces by the second inner and outer supplementary permanent magnets 255, 256, so that the downwardly moved state of the movable member 240 can be continuously maintained even though the current supply to the coil 241 is interrupted.

A plurality of non-magnetic rods 271 are connected to an end (upper end in FIG. 8) of the movable member 240. A supporting member 281 may be provided to ends of the non-magnetic rods 271. The supporting member 281 is provided with a connecting part 281a in which an aperture 281b is formed. The connecting part 281a is connected to a driven part such as a circuit breaker through the aperture 281b.

To other end (lower end in FIG. 8) of the movable member 240 may be also connected a plurality of non-magnetic rods 272. The non-magnetic rods 272 may be provided with a supporting member 282.

In order to prevent the end of the movable member from colliding with the body 210 at the end of the axial movement of the movable member 240, first and second buffering means 261, 262 may be provided to both ends of the movable member 240. In this embodiment, the first and second buffering means 261, 262 consist of a compressible coil spring and are positioned between the inner and outer permanent magnets 220, 230. The first and second buffering means 261, 262 are not limited to the form shown in FIG. 8. For example, a hydraulic or pneumatic damper may be mounted to an exterior of the actuator 100. In addition, the buffering means may be mounted to the exterior of the body 210, rather than to the interior as shown in FIG. 8.

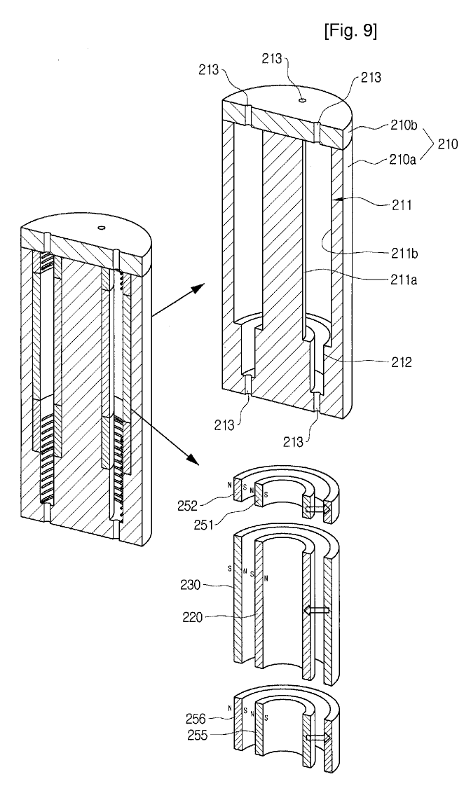

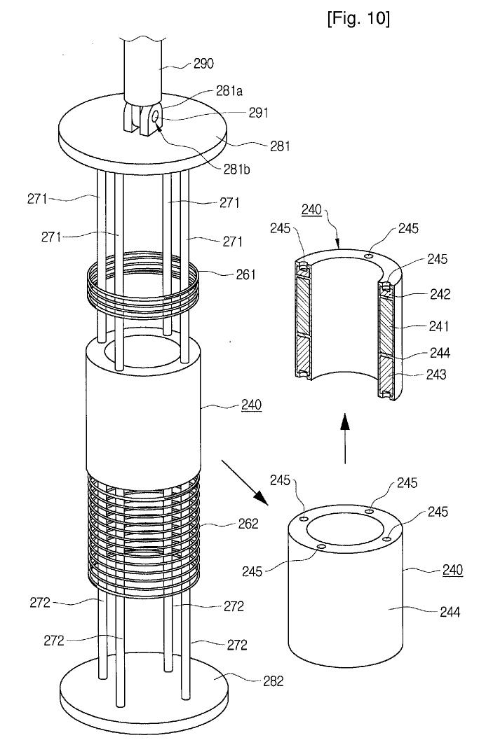

FIGS. 9 and 10 are detailed views showing the constituting elements shown in FIG. 8.

FIG. 9 shows specific shapes of the body 210, the inner and outer permanent magnets 220, 230, the first inner and outer supplementary permanent magnets 251, 252 and the second inner and outer supplementary permanent magnets 255, 256. The body 210 is formed with the circular chamber 211 therein. Accordingly, the chamber 211 has an inner wall surface 211a and an outer wall surface 211b. In order to form the circular chamber 211 and to assemble the inner and outer permanent magnets 220, 230 and the movable member 240 in the body 210, the body 210 can be divided into the first body 210a and the second body 210b. An extending recess 212 for mounting the second buffering means 262 may be formed in a lower part of the second body 210b. The extending recess 212 is provided when a length of the second buffering means 262 is long. A plurality of through-holes 213 are formed in both ends of the body 210 to pass through the rods 271.

The polarities of the inner and outer permanent magnets 220, 230 are positioned so that the lines of magnetic force thereof flow in an arrow direction, i.e., a radially inward direction. The polarities of the first inner and outer supplementary permanent magnets 251, 252 and the second inner and outer supplementary permanent magnets 255, 256 are positioned to be opposite to those of the inner permanent magnet 220 and the outer permanent magnet 230. Although the inner and outer permanent magnets 220, 230, the first inner and outer supplementary permanent magnets 251, 252 and the second inner and outer supplementary permanent magnets 255, 256 are shown to be continuous circular shapes in Figs., they may have radially divided shapes.

FIG. 10 shows detailed shapes of the first and second buffering means 261, 262. As described above, the movable member 240 has such a structure that the coil 240 and the first and second magnetic rings 242, 243 are embedded to be integrated with the insulating housing 244. The insulating housing 244 may be made of plastic material. In this case, the coil 241 and the first and second magnetic rings 242, 243 may be easily embedded by injection-molding the housing 244 using an insert method. Both ends of the movable member 240 are formed with a plurality of recesses 245 for connecting the rods 271. The rod 271 may be connected to the recess using for example, a screw fastening method. Meanwhile, when the first and second buffering means 261, 262 consist of a compressible spring and are mounted in the body 210, the compressible springs 261, 262 may be mounted in the manner of surrounding the exterior of the non-magnetic rods 271, 272. The supporting member 281 fixed to the ends of the rods 271 is formed with the connecting part 281a. An actuating rod 280 is connected to the connecting part 281a by a connection of the aperture 281b and a shaft 291. The actuating rod 290 is connected to a driven part such as a circuit breaker, so that it drives the driven part by the axial movement of the movable member 240.

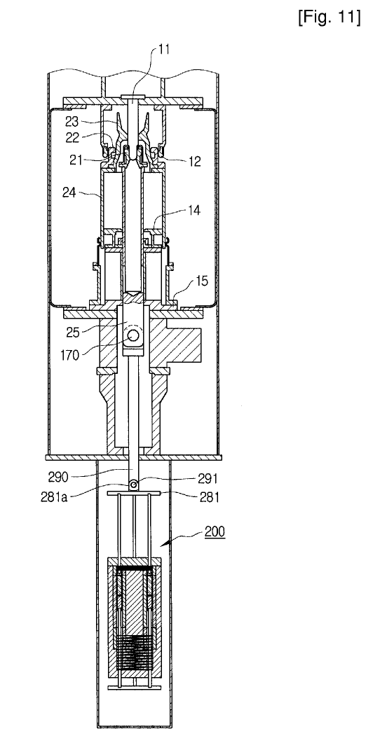

FIG. 11 shows a circuit breaker having the actuator 200 according to the second embodiment. The circuit breaker shown in FIG. 11 has such a structure that only the circuit breaker and the actuator explained with reference to FIGS. 5 to 7 are different and the remaining parts are same. FIG. 11 shows that the circuit breaker maintains its closed state.

As shown in FIG. 11, in the circuit breaker according to this embodiment, the insulation-actuating rod 25 of the circuit breaker is connected with the actuating rod 290 by the pin 170 and the actuating rod 290 is connected to the supporting member 281 of the actuator 200. Accordingly, the insulation-actuating rod 25 is axially moved by the movement of the supporting member 281, thereby performing closing and opening operations. The supporting member 281 is connected to the movable member 240 and is thus driven by the axial movement of the movable member 240.

Specifically, one end of the insulation-actuating rod 25 is connected to the connecting part 281a of the supporting member 280 through the shaft 291.

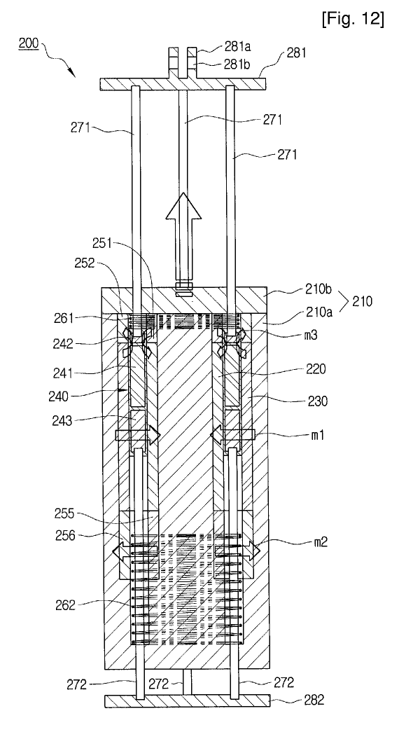

FIGS. 12 to 15 sequentially show operating procedures of the actuator 200 according to the second embodiment of the invention. It will be explained on the assumption that the actuator 200 is applied to the circuit breaker shown in FIG. 11.

FIG. 12 shows that the movable member 240 is upwardly moved to the first inner and outer supplementary permanent magnets 251, 252 to the utmost. Accordingly, the supporting member 281 is also upwardly moved to the utmost to push up the actuating rod 290 (not shown), so that the circuit breaker maintains its closed state. An arrow (m1) indicates the directions of the lines of magnetic force of the inner and outer permanent magnets 220, 230, an arrow (m2) indicates the directions of the lines of magnetic force of the second inner and outer supplementary permanent magnets 255, 256, and an arrow (m3) indicates the directions of the lines of magnetic force of the first inner and outer supplementary permanent magnets 251, 252. When the movable member 240 is upwardly moved to maintain the closed state of the circuit breaker, the coil 241 of the movable member 240 is not supplied with the current. The first magnetic ring 242 of the movable member 240 serves as a flow path of the lines of magnetic force occurring from the inner and outer permanent magnets 220, 230 and the first inner and outer supplementary permanent magnets 251, 252. At the same time, since the first magnetic ring 242 is already slanted toward the first inner and outer supplementary permanent magnets 251, 252, the forces (magnetic forces) by the magnetic fields of the first inner and outer supplementary permanent magnets 251, 252 affect on the first magnetic ring 242. The force acts as a holding force of holding the first magnetic ring 242, so that the upwardly moved state of the movable member 240 is continuously maintained. Accordingly, the circuit breaker can continuously maintain its closed state. At this time, the movable member 240 cannot be upwardly moved beyond a predetermined limit due to the first buffering means 261 and is stopped at a point at which the holding forces by the first inner and outer supplementary permanent magnets 251, 252 are balanced with an elastic restoring force of the first buffering means 261.

When there occurs an abnormality in the electric power system, the current is supplied to the coil 241 so as to open the circuit breaker. Then, a repulsive force (axial force) acts due to a relationship of the magnetic flux density occurring between the inner and outer permanent magnets 220, 230 and the current density occurring from the coil 241, so that the coil 241 is downwardly moved. In other words, the movable member 240 is downwardly moved. In this case, the current, which has a magnitude high enough to overcome the holding forces of holding the first magnetic ring 242 by the first inner and outer supplementary permanent magnets 251, 252 under the closed state, is supplied to the coil 241, is supplied to the coil 241.

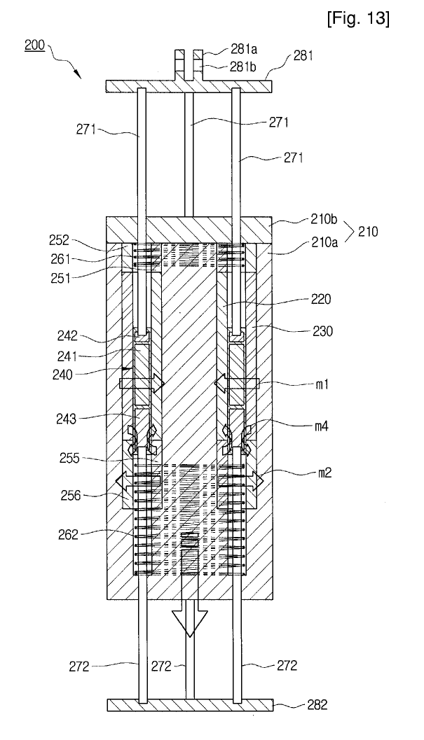

When the movable member 240 is downwardly moved to a position shown in FIG. 13, since the repulsive force acting on the coil 241 and the axial moving force by an inertia force occurring due to the movement of the movable member 240 are much higher than the force drawing the first magnetic ring 241 upwardly, the movable member 240 can continue to downwardly move. In addition, the second magnetic ring 242 goes toward the second inner and outer supplementary permanent magnets 255, 256, thereby serving as the flow path of the lines of magnetic force occurring from the inner and outer permanent magnets 220, 230 and the second inner and outer supplementary permanent magnets 255, 256. Accordingly, the force that the second inner and outer supplementary permanent magnets 255, 256 draw the second magnetic ring 243 downwardly is gradually increased, so that the movable member 240 is applied with the higher downward force and thus accelerated. At this point of time, the actuator 200 shows the highest force. Accordingly, it is preferably designed such that this point is matched up with the point of time that the gas repulsive force (which is a force of drawing the puffer cylinder 24 to the direction opposing to the fixed piston 14 in FIG. 6) is highest in the contacting parts of the circuit breaker.

Like this, when the movable member 240 continuously speeds up and then passes by the point shown in FIG. 13, the current supplied to the coil 241 is rapidly interrupted. By doing so, the movable member 240 is moved only by the inertia force and the force which the second inner and outer supplementary permanent magnets 255, 256 draw the second magnetic ring 243 downwardly.

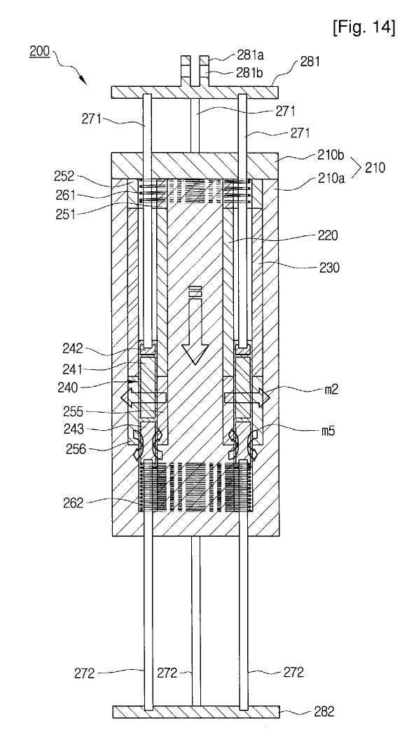

When the movable member 240 is downwardly moved to a position shown in FIG. 14, the second inner and outer supplementary permanent magnets 255, 256 pushes the second magnetic ring 242 in a reverse direction to the movement (i.e., upward direction). In other words, from when the second magnetic ring 242 of the movable member 240 passes by a axial middle point of the second inner and outer supplementary permanent magnets 255, 256, a force acting in the reverse direction to the movement of the movable member 240 occurs, thereby stopping the movable member 240. At this point of time, since the opening operation is already completed at the contacting points of the circuit breaker, the higher the stopping force, the less occurs that the lower end of the movable member 240 collides with the body 210. Accordingly, it is possible to achieve a mechanical stabilization. However, since the movable member 240 actually moves at high speed such as 6 m/s or more, there is a worry that the movable member 240 passes by the second inner and outer supplementary permanent magnets 255, 256 and thus collides with the body 210. In this case, the movable member 240 can be stably slowed down by the second buffering means 262.

At the end of the downward movement of the movable member 240, the force which the second buffering means 262 and the second inner and outer supplementary permanent magnets 255, 256 push the movable member 240 in the reverse direction to the movement is typically higher than the holding force of holding the second magnetic ring 243 by the second inner and outer supplementary permanent magnets 255, 256.

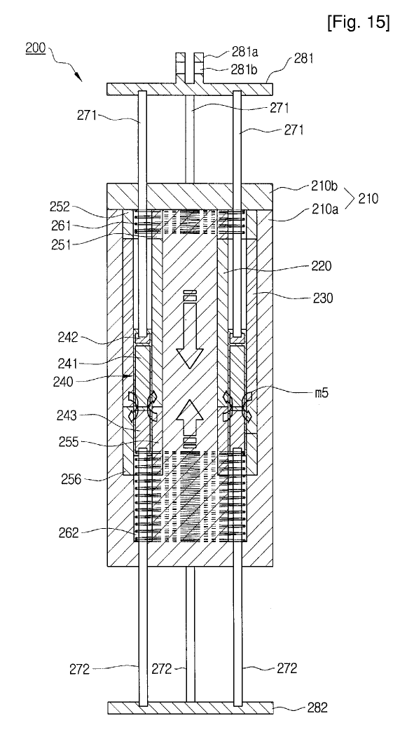

Therefore, as shown in FIG. 15, the movable member 240 is upwardly moved by the restoring force of the second buffering means 262. Finally, the movable member 240 is stopped at a point at which the restoring force of the second buffering means 262 is balanced with the holding force of the second magnetic force 230 by the second inner and outer supplementary permanent magnets 255, 256. This time is that the opening of the circuit breaker is completed.

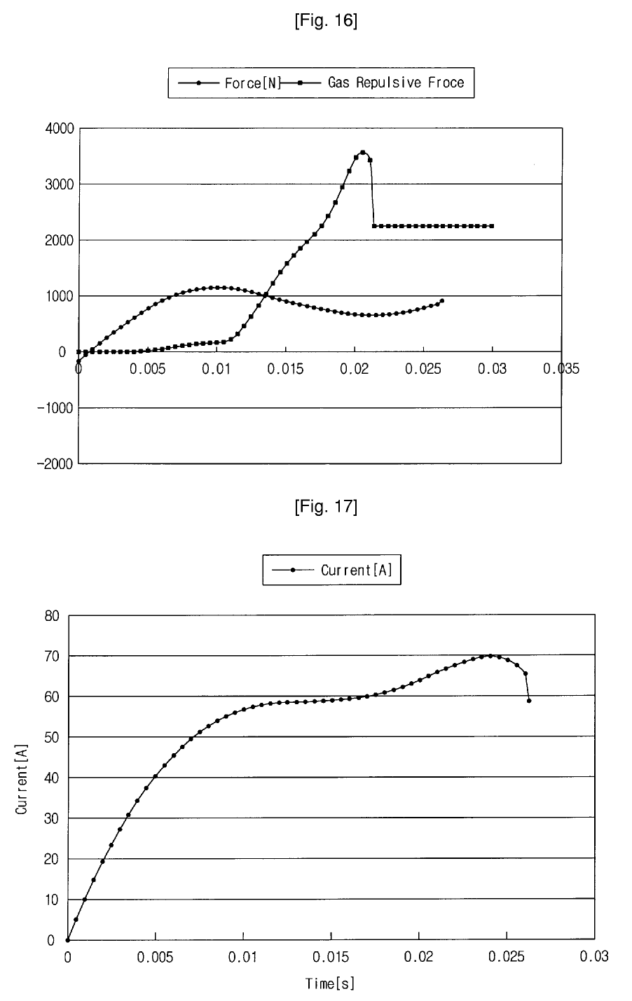

FIGS. 16 to 21 are simulation results showing that the electromagnetic force driving actuator 200 according to the second embodiment of the invention is applied to the circuit breaker.

FIGS. 16 and 17 show characteristics of a force moving the movable member 240 and the current when the actuator according to the second embodiment of the invention includes only the inner and outer permanent magnets 220, 230 without the first and second magnetic rings 242, 243 and the supplementary permanent magnets 251, 252 and 255, 256. Although the current continues to increase, the force moving the movable member 240 increases only at an early state and suddenly decreases. However, the gas repulsive force of the circuit breaker becomes highest at a point at which the actuation of the movable member 240 is nearly ended. Accordingly, it may be somewhat difficult to use the actuator model without the first and second magnetic rings 242, 243 and the supplementary permanent magnets 251, 252 and 255, 256 for the super-high pressure circuit breaker.

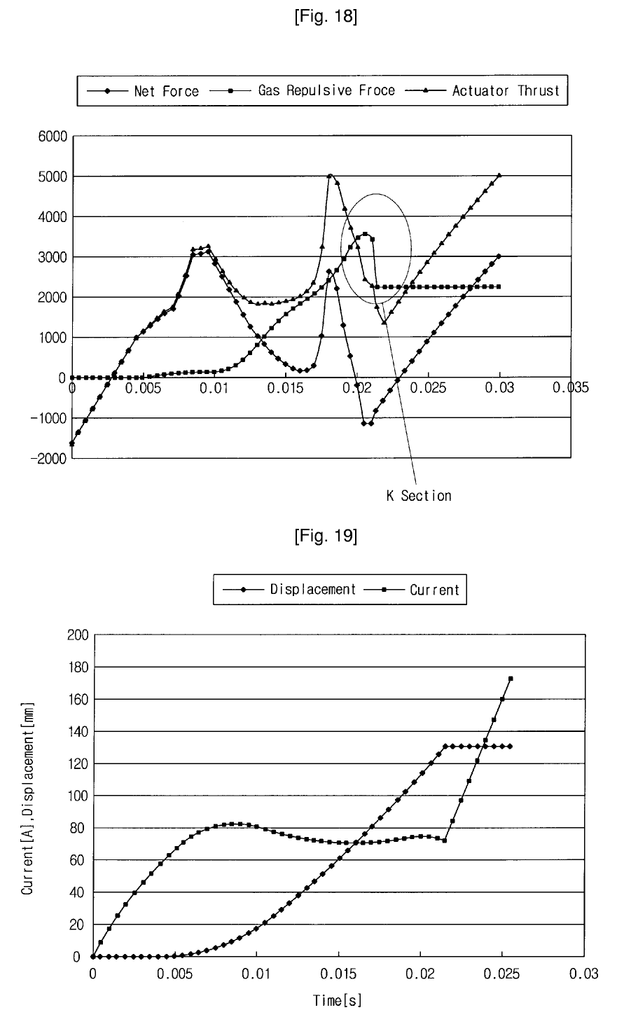

FIGS. 18 and 19 show characteristics of a force moving the movable member 240 and the current when the actuator includes the first and second magnetic rings 242, 243 and the supplementary permanent magnets 251, 252 and 255, 256. That is, FIGS. 18 and 19 show the characteristics when the supplementary permanent magnets 251, 252 and 255, 256 are mounted to the upper and lower parts of the inner and outer permanent magnets 220, 230 and the first and second magnetic rings 242, 243 are mounted to the upper and lower parts of the coil 241. In this case, it is possible to eliminate the phenomenon that the force is reduced as the movable member 240 is moved, which is a problem in FIGS. 16 and 17.

In FIG. 18, a line connecting quadrangle-shaped points indicates a gas repulsive force of the circuit breaker, a line connecting triangle-shaped points indicates an electro-magnetic force occurring from a pure actuator (actuator thrust) and a line connecting rhombus-shaped points indicates a net force of the actuator overcoming the gas repulsive force of the circuit breaker and operating. The speed of the movable member becomes fast only when the electromagnetic force occurring in the pure actuator is higher than the gas repulsive force. As explained in FIGS. 16 and 17, the electro-magnetic force increases at the early stage of the movement of the movable member and then decreases. However, as can be seen from FIG. 18, the electromagnetic force slightly decreases while passing by the early stage and then again increases at the later stage. In other words, the point of time that the force increases again is a point of time that the magnetic ring of the movable member is close to the supplementary permanent magnets. Accordingly, the force acting on the movable member becomes higher, so that an overall speed of the movable member continues to increase without decreasing.

In FIG. 18, the electromagnetic force is lower than the gas repulsive force in ‘K section’. However, since the inertia force of the movable member is very high in the K section, the speed of the movable member is not much decreased as shown in ‘displacement’ graph of FIG. 19 and the movable member can still speed highly. For example, to make the gas repulsive force not higher than the electromagnetic force of the pure actuator is a preferred optimized design of the circuit breaker. However, since the maximum value of the gas repulsive force is changed every time, the above problem is not serious only if the inertia force of the movable member is sufficiently high.

### Example 3

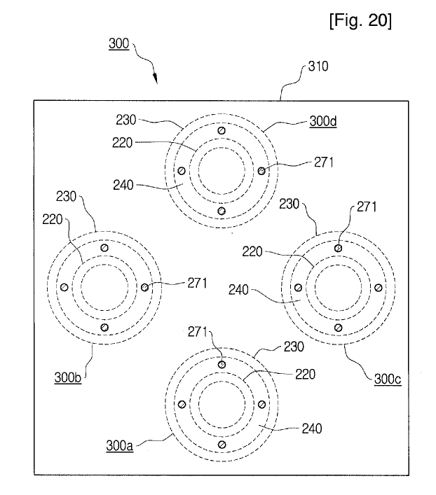

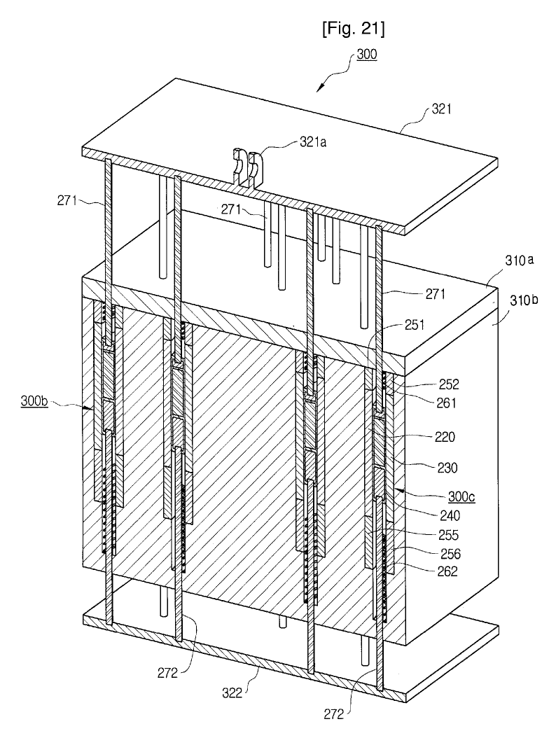

FIGS. 20 and 21 show an electromagnetic force driving actuator 300 according to a third embodiment of the invention. The actuator 300 according to the third embodiment is such that a plurality of the actuators 200 (four in Figs.) according to the second embodiment are mounted to one body 310. In other words, a plurality of actuating parts 300a, 300b, 300c, 300d may be mounted to the body 310 made of magnetic material. Each of the actuating parts 300a, 300b, 300c, 300d comprises the inner and outer permanent magnets 220, 230, the movable member 240 having the coil and the first and second magnetic rings, the first and second inner and outer supplementary permanent magnets 251, 252 and 255, 256 and the first and second buffering means 261, 262, likewise the actuator according to the second embodiment. Each of the movable members 240 is connected with the plurality of rods 271, 272 which are connected to supporting members 321, 322. The upper supporting member 321 is provided with a connecting part 321a for connecting to the circuit breaker. The actuator 300 according to the third embodiment is a preferred structure when the number of the actuators is increased as the breaking capacity is increased.

In the mean time, with the actuators according to the first, second and third embodiments and the circuit breakers applied with the actuators, it is possible to maximize an efficiency of the actuator by increasing the magnetic flux density using a superconducting magnet (or superconducting bulk magnet). Since the actuators suggested by the invention are operated by the electromagnetic repulsive force occurring from the magnetic flux density of the permanent magnet and the current density of the coil, they can have higher force and speed when the superconducting magnet is used rather than the existing permanent magnet, because the magnetic flux density becomes higher.

$$E = \frac{1}{2} ( BH ) = \frac{{B}^{2}}{2 μ}$$

As can be seen from the above equation, an energy (E) is proportional to a square to a magnetic flux density (B). A magnetic flux density of a Nd (neodymium)-based permanent magnet having a relatively high magnetic flux density among the general permanent magnets is typically 1.2 Tesla (T), while a magnetic flux density of a currently developed superconducting magnet (or superconducting bulk magnet) is about 3 T-12 T much higher than those of the general permanent magnets. If a superconducting magnet having about 3 T of magnetic flux density is applied, the magnetic flux density is about three times compared to the general permanent magnet having about 1 T of magnetic flux density and the energy is nine times. Accordingly, when applying the same amounts of current density, the force becomes about 9 times. Like this, it is possible to increase the efficiency by replacing the general permanent magnet with the superconducting magnet. In the actuator according to the first embodiment, it is possible to increase the efficiency of the actuator just by replacing the general permanent magnet with the superconducting magnet. However, when using the force occurring between the main permanent magnets (inner and outer permanent magnets) and the supplementary permanent magnets (first and second inner and outer supplementary permanent magnets) so as to bear the gas repulsive force, as the actuator according to the third embodiment, a problem occurs if the superconducting magnet is used for both the main and supplementary permanent magnets. Although the superconducting magnet exhibits a constant magnetic flux density like the general permanent magnet, the magnetic field occurred in the exterior is not introduced into the superconducting magnet due to the superconducting property (Meissner effect). Therefore, according to the invention, the superconducting magnet is used for the main permanent magnet and the general permanent magnet is used for the supplementary permanent magnet so that the magnetic field occurred in the exterior can flow through the general permanent magnet. Accordingly, it can be made to exert a high force when the magnetic ring of the actuating part is positioned in the boundary of the superconducting magnet and the general permanent magnet.

### INDUSTRIAL APPLICABILITY

As described above, according to the invention, since the actuator has such structure that the movable member is operated with the electromagnetic repulsive forces occurring due to the magnetic filed of the permanent magnet and the current density of the coil, it is possible to exhibit higher actuating force and speed even with small size and weight.

In addition, according to the circuit beaker of the invention, since the closing operation is performed with the high force and speed, the breaker can be easily applied for the low pressure circuit breaker as well as for the high/super-high pressure circuit breaker.

While the invention has been shown and described with reference to certain preferred embodiments thereof, it will be understood by those skilled in the art that various changes in form and details may be made therein without departing from the spirit and scope of the invention as defined by the appended claims.

1. An electromagnetic force driving actuator comprising:
a hollow inner case made of magnetic material;
an outer case made of magnetic material and being concentric with the inner case and radially mounted at an interval outwardly from the inner case;
inner and outer permanent magnets abutting on an outer surface of the inner case and an inner surface of the outer case, respectively and positioned to maintain a predetermined gap between the magnets;
a coil mounted to be linearly movable in an axial direction between the inner and outer permanent magnets; and
a non-magnetic movable member having an end to which the coil is provided and linearly moving in the axial direction between the inner and outer permanent magnets with electromagnetic repulsive forces occurring due to magnetic fields by the inner and outer permanent magnets and a current density of the coil when current is supplied to the coil.

2. The actuator as claimed in claim 1, wherein the non-magnetic movable member comprises:
a movable ring having an end to which the coil is provided and being mounted to be linearly movable in the axial direction between the inner and outer permanent magnets; and
a movable shaft mounted to be linearly movable in the inner case and linearly moving in the axial direction by the movable ring due to an end thereof connected to the movable ring.

3. The actuator as claimed in claim 1, wherein the inner and outer permanent magnets consist of a superconducting magnet.

4. The actuator as claimed in claim 1, further comprising first and second end plates made of magnetic material and blocking both ends of the inner and outer cases to induce a smooth flow of the magnetic fields.

5. A circuit breaker comprising:
a hollow inner case made of magnetic material;
an outer case made of magnetic material and being concentric with the inner case and radially mounted at an interval outwardly from the inner case;
inner and outer permanent magnets abutting on an outer surface of the inner case and an inner surface of the outer case, respectively and positioned to maintain a predetermined gap between the magnets;
a coil mounted to be linearly movable in an axial direction between the inner and outer permanent magnets;
a non-magnetic movable member having an end to which the coil is provided and linearly moving in the axial direction between the inner and outer permanent magnets with electromagnetic repulsive forces occurring due to magnetic fields by the inner and outer permanent magnets and a current density of the coil when current is supplied to the coil; and
an insulation-actuating rod connected to another end of the movable member and linearly moving by the movable member to perform closing and opening operations.

6. The circuit breaker as claimed in claim 5, wherein the inner and outer permanent magnets consist of a superconducting magnet.

7. The circuit breaker as claimed in claim 5, wherein the non-magnetic movable member comprises:
a movable ring having an end to which the coil is provided and being mounted to be linearly movable in the axial direction between the inner and outer permanent magnets; and
a movable shaft mounted to be linearly movable in the inner case, having an end connected to the movable ring and another end connected to the insulation-actuating rod and linearly moving in the axial direction by the movable ring to move the insulation-actuating rod.

8. The circuit breaker as claimed in claim 5, further comprising first and second end plates made of magnetic material and blocking both ends of the inner and outer cases to induce a smooth flow of the magnetic fields.

9. The circuit breaker as claimed in claim 5, further comprising a buffering means mounted adjacent to a region that is at an end of the opening movement of the movable member and absorbing a shock force.

10. The circuit breaker as claimed in claim 9, wherein the buffering means consists of a compressible coil spring.

11. An electro-magnetic force driving actuator comprising:
a body made of magnetic material and having a circular chamber formed therein;
circular inner and outer permanent magnets concentrically mounted to maintain a radial interval in the chamber of the body; and
a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil.

12. The actuator as claimed in claim 11, wherein both ends of the inner and outer permanent magnets are provided with first circular inner and outer supplementary permanent magnets and second circular inner and outer supplementary permanent magnets, respectively, and the movable member is integrated with the coil by positioning first and second circular magnetic rings to both ends of the coil, respectively.

13. The actuator as claimed in claim 12, wherein polarities of the first inner and outer supplementary permanent magnets and the second inner and outer supplementary permanent magnets are opposite to those of the inner and outer permanent magnets.

14. The actuator according to claim 12 or 13, wherein the inner and outer permanent magnets consist of a superconducting magnet.

15. The actuator as claimed in claim 12, wherein the coil and the first and second magnetic rings are embedded in an insulating housing to be integrated with it.

16. The actuator as claimed in claim 15, wherein the insulating housing is made of plastic material.

17. The actuator as claimed in claim 11, wherein both ends of the movable member are provided with first and second buffering means in order to prevent the ends of the movable member from colliding with the body at the end of the axial movement of the movable member.

18. The actuator as claimed in claim 17, wherein the first and second buffering means consist of a compressible coil spring.

19. The actuator as claimed in claim 17, wherein the first and second buffering means consist of a compressible coil spring and are positioned between the inner and outer permanent magnets.

20. The actuator as claimed in claim 11, wherein a plurality of non-magnetic rods are connected to an end of the movable member and a supporting member is mounted to ends of the non-magnetic rods for connecting to a driven part.

21. A circuit breaker comprising:
a body made of magnetic material and having a circular chamber formed therein;
circular inner and outer permanent magnets concentrically mounted to maintain a radial interval in the chamber of the body; and
a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil; and
an insulation-actuating rod connected to the movable member in order to linearly move by the movable member of the actuator and thus to perform opening and closing operations.

22. The circuit breaker as claimed in claim 21, wherein both ends of the inner and outer permanent magnets are provided with first circular inner and outer supplementary permanent magnets and second circular inner and outer supplementary permanent magnets, respectively, and the movable member is integrated with the coil by positioning first and second circular magnetic rings to both ends of the coil, respectively.

23. The circuit breaker as claimed in claim 22, wherein the inner and outer permanent magnets consist of a superconducting magnet.

24. An electromagnetic force driving actuator comprising:
a plurality of electromagnetic force driving actuating parts mounted in a body made of magnetic material, each of the actuating parts including:
circular inner and outer permanent magnets concentrically mounted to maintain a radial interval between the magnets;
a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil;
a plurality of rods connected to the movable members; and
a supporting member connecting ends of the rods.

25. The actuator as claimed in claim 24, wherein both ends of the inner and outer permanent magnets are provided with first circular inner and outer supplementary permanent magnets and second circular inner and outer supplementary permanent magnets, respectively, and the movable member is integrated with the coil by providing first and second circular magnetic rings to both ends of the coil, respectively.

26. The actuator as claimed in claim 25, wherein the inner and outer permanent magnets consist of a superconducting magnet.

27. A circuit breaker comprising:
a plurality of electromagnetic force driving actuating parts mounted in a body made of magnetic material; and
each of the actuating parts including:
circular inner and outer permanent magnets concentrically mounted to maintain a radial interval between the magnets;
a movable member having a circular coil, mounted to be linearly movable in an axial direction between the inner and outer permanent magnets and linearly moving in the axial direction between the inner and outer permanent magnets with electromagnetic repulsive forces occurring due to magnetic fields by the inner and outer permanent magnets and a current density of the coil when current is supplied to the coil;
a plurality of rods connected to the movable members; and
a supporting member connecting ends of the rods,
an insulation-actuating rod connected to the supporting member in order to linearly move by the movable members and thus to perform closing and opening operations.

28. The circuit breaker as claimed in claim 27, wherein both ends of the inner and outer permanent magnets are provided with first circular inner and outer supplementary permanent magnets and second circular inner and outer supplementary permanent magnets, respectively, and the movable member is integrated with the coil by providing first and second circular magnetic rings to both ends of the coil, respectively.

29. The circuit breaker as claimed in claim 28, wherein the inner and outer permanent magnets consist of a superconducting magnet.
